(19) United States
(12) Patent Application Publication
(10) Pub. No.: US 2010/0215551 A1
(43) Pub. Date: Aug. 26, 2010

(54) Tyer hot gas filter and fluidized bed media cleaner

(76) Inventor: Robert Clark Tyer, SR., Jackson, FL (US)

Correspondence Address: Robert Clark Tyer Sr., 12794 Burning Tree Lane West, Jacksonville, FL, 32223, US

(21) Appl. No.: 12/658,678

(22) Filed: Feb. 12, 2010

Related U.S. Application Data
(60) Provisional application No. 61/207,651, filed on Feb. 13, 2009.

(51) Int. Cl. B01J 8/18

(52) U.S. Cl. 422/145

(57) ABSTRACT

The gasifier described includes, in its preferred embodiments, a vertically elongated (“oblong”) primary gasifier chamber with an auger and a fluidized bed, allowing for large amounts of fuel input when necessary. The gasifier further includes a gas treatment chamber receiving gases discharged from the gasifier chamber. The fluidized bed in the gasifier chamber as well as the gas treatment chamber contain metallic particles, with these metallic particles circulating in a closed loop between the gasifier chamber and the gas treatment chamber. This system offers numerous benefits. Some or all of said metallic particles can serve as a catalyst in the gasification of the gasifiable materials being processed, including serving as a catalyst for a Fisher Tropsch chemical process in the gasification of said gasifiable materials. In the gas treatment chamber particularly, some or all of said metallic particles serve to clean gases produced in the gasification of said gasifiable materials. The metallic particles can have sizes chosen to provide ate least one of a selected contact area for gases in the gas treatment chamber, and a selected limit on backpressure for an adequate gas stream flow to gas stream cleaning ratio. Also, the metallic particles have a heat retention capacity and this heat retention capacity serves to stabilize the operating temperature of the gasifier. The metallic composition of the metallic particles keeps them from becoming entrained in the gases being discharged from the gasifier chamber, and it is also possible to use the metallic composition of the particles to magnetically separated them from ash issuing from the gasifier chamber (as part of their closed loop circulation). In this circulation, the metallic particles pick up residues in the gas treatment chamber (cleaning the gases passing therethrough), and are cleaned in turn when they pass back through the gasifier chamber. Finally, the overall system allows an oxygen deprived environment and an elevated pressure to be maintained in said gasifier chamber during the closed loop circulation of metallic particles between the gasifier chamber and the gas treatment chamber, promoting maximum efficiency in the gasification process.

### CROSS-REFERENCE TO RELATED APPLICATIONS

This application claims subject matter disclosed in a provisional application filed Jan. 14, 2009, application Ser. No. 61/205,055 entitled “Combined Cycle Gasifier” and a Non-Provisional application filed Feb. 20, 2009, application Ser. No. 12/378,864, entitled “Improved Auger Combustor”. The benefit under 35 USC §309(e) of the United States provisional application is hereby claimed. The aforementioned applications are hereby incorporated herein by reference.

### BACKGROUND AND SUMMARY

The invention relates generally to fluidized bed gasifiers and to the production of gasified fuel via and/or in conjunction with the gasification of solid fuels in a fluidized bed gasifier featuring a rotating auger conveyor. More particularly, it describes a gasifier utilizing metallic particles to form a fluidized bed in the primary gasifier chamber, for cleaning/treatment of gases produced in the primary gasifier chamber in a gas treatment chamber, and a system for circulating said particles between said two chambers in a closed loop with many attendant benefits. As such, it deals with improvements to gasifiers that facilitate the continuous controlled movement and gasification of solid fuels in the combustor/gasifier, and which facilitate production and enrichment of gasified fuel via and in conjunction with such combined cycle gasification system. These and other improvements taught herein are in relation to the operation of an auger gasifier(s) and/or plural thermodynamic cycle gasification systems.

The use of an auger represents significant advances in technology related to the environmentally sound utilization and processing of bioenergy fuels, such as, but not limited to, solid fuel for the production of energy via such fluidized bed gasifiers and plural thermodynamic cycle gasification systems. Much of the world's energy needs have been, and continue to be, filled by hydrocarbon fuels. In the past, such fuels provided a convenient, plentiful, and inexpensive energy source. The current rising costs of such fuels and concerns over the adequacy of their supply in the future has made them a less desirable energy source and has led to an intense investigation of alternative sources of energy. The ideal alternative energy source is a fuel that is renewable, inexpensive, and plentiful, with examples of such fuels being, but not limited too, the byproducts of wood, pulp, and paper mills, household municipal solid waste (MSW), commercial refuse-derived fuel (RDF). In addition, biomass fuels are a renewable energy source because they are biological material derived from living, or recently living organisms, such as wood, waste, and alcohol fuels and are considered carbon-neutral since the C_{O2} liberated from the gasification of biomass fuels are recycled in plants. The combusted biomass fraction of RDF is used by stationary combustion operators to reduce their overall reported C_{O2} emissions.

Refuse-derived fuel (RDF) and municipal solid waste (MSW) consists largely of organic components of municipal waste such as plastics and biodegradable waste. For example, forest residues (such as dead trees, branches and tree stumps), yard clippings and wood chips may be used as biomass; however, biomass also includes plant or animal matter used for production of fibers or chemicals.

Biomass may also include biodegradable wastes that can be gasified as fuel and industrial biomass that can be grown from numerous types of plant including, such as but not limited too, miscanthus, switch grass, hemp, corn, poplar, willow, sorghum, sugarcane, and a variety of tree species, ranging from eucalyptus to oil palm, but excludes organic material such as fossil fuel substances such as coal or petroleum.

The use of such alternative energy sources is not problem-free. There is reason for concern over the contents of the emissions from the combustion of such fuels as well as the environmental ramifications of acquiring and transporting the fuel and disposing the residue of combustion. Starved-air gasifiers, wherein the air supplied for gasification is controlled in order to control temperature conditions (and the rates of gasification) to gasify the fuel as completely as possible, have proved very useful in the utilization of such alternative energy sources while simultaneously maintaining a high degree of environmental quality in emissions. Such starved-air gasifiers are capable of gasifying various types of fuel and producing significant amounts of synthesis gas and heat that can be employed for any number of purposes including the production of process steam for use in manufacturing and in the generation of electricity by combining a plurality of thermodynamic cycles.

Unfortunately, most starved-air gasifiers, as originally developed and operated, were not entirely satisfactory in processing the gasifiable elements of the fuel at high throughput while not producing noxious emissions. This problem resulted, in part, from the use of such gasifiers to burn a wide variety of fuels, including many that were non-homogeneous, such as household municipal solid waste (MSW) and commercial refuse-derived fuel (RDF). While the pollution problem can be solved to a degree by the utilization of scrubbers and other antipollution devices, such mechanisms are very expensive and their cost may militate against the use of alternative energy sources previously described.

Many of the drawbacks of such prior art devices were overcome by the development of the auger gasifier by the inventor and others. See, U.S. Pat. No. 4,009,667 (describing the original auger gasifier utilized in the system); U.S. Pat. No. 4,315,468 (describing a control means for the system); U.S. Pat. No. 4,331,084 (describing a refuse fuel feed mechanism for the system); U.S. Pat. No. 4,331,085 (describing a flame stabilization means for the system); U.S. Pat. No. 4,332,206 (describing an afterburner for the system); U.S. Pat. No. 4,332,206 (describing a hot gas recycle mechanism for use with the system); and U.S. Pat. No. 6,349,658 (describing an auger gasifier with fluidized bed). The auger gasifier technology taught and described in the foregoing patents offers a cost-effective approach to clean, efficient gasification of biomass fuels and other prepared solid waste fuels.

The application of fluidized bed technology has been well accepted in the field of solid fuel gasification. Many versions of the fluidized bed have been developed to provide adequate heat transfer to the solid fuel particles. Historically, an example of the bed media has been sand, gravel, limestone. These media types have limitations and this patent demonstrates many advantages over conventional fluidized bed media.

The first advantage of this patent is that the metallic particle bed is not subject to being entrained with the gas stream. Further, as this patent clearly demonstrates, the metallic particle bed media can be used within a collection chamber described as a filter section through which flue gases can be routed and gas clean-up will take place. Conventional fluidized bed media such as, but not limited to, sand, gravel or limestone would become entrained in the gas stream and be conveyed to the boiler, turbine, internal combustion engine with catastrophic consequences if used as a final gas filter. (It is possible to filter out entrained conventional fluidized bed media but the equipment cost and maintenance could be prohibitive).

Another advantage of the use of metallic particle fluidized bed media in an auger gasifier is its heat retention qualities that help to stabilize the heat within the total system. Once heated, the metallic particles tend to retain the heat even as they are transported from the auger gasifier to the secondary chamber filter. As illustrated, the filter section retains an adequate number of heated metallic particles to form a filter mesh. The volume and diameter of the metallic particles can be selected to provide the desired gas stream contact area as well as the desired limit of backpressure for an efficient gas stream flow to adequate gas stream cleaning ratio. The heat retained within the metallic particle media will cause residues within the gas stream to collect on the surface of the metallic particles. All of the hot residue coated metallic particles will travel from the filter section to the internal chamber of the auger gasifier.

The gasification environment within the auger gasifier will gasify the residue coating on the metallic particle media simultaneously with the raw feedstock. This results in less discharge of disposable ash. The metallic particle media will retain heat to stabilize the system, filter the gas stream and reduce the ultimate production of disposable ash.

Accordingly, the instant invention represents a significant advance in technology related to the environmentally sound utilization and processing of bio-energy flue gas and/or synthesis gas. In addition, my process in cleaning synthesis gas and/or flue gas has numerous advantages over prior art; such as but not limited too: reducing waste residue emitted from the flue gas cleaning processes. When the waste residue attaches to the metallic particles, I can recycle the metallic particles into the gasifier for cleaning. Thus, the instant invention and process includes advancements in hot gas filtering as well as fluidized bed technology. These advancements are applicable to any gasifier, combustor, plural thermodynamic cycle gasification systems and/or process that either produce a flue gas and/or synthesis gas and/or uses a fluidized bed process.

### BRIEF DESCRIPTION OF THE DRAWING

FIG. 1 provides a schematic illustration of the invention.

### DETAILED DESCRIPTION

As previously described in Ser. No. 12/378,864, entitled “Improved Auger Combustor” the teachings of which are incorporated herein by reference, it is very beneficial in terms of the more rapid processing and gasification of fuels 15 in a gasifier chamber 9 to be able to control the pressure in chamber 9 as necessary for more rapid gasification and processing of various fuel types, and more particularly, to be able to keep chamber 9 at an elevated pressure (requiring chamber 9 to serve as a pressure vessel). Overall, the interior of chamber 9 will be maintained at a pressure of at least atmospheric pressure, but less than the engineered limits of gasifier chamber 9 as a pressure vessel. However, it has been found to be advantageous in the rapid gasification of fuel to be able to maintain chamber 9 pressure at or above approximately 2 atmospheres (i.e., approximately at least 30 psi). Obviously, in order to control pressure in chamber 9, provision must be made to control ingress and egress of gases from chamber 9 via the various inlets and outlets for auger gasifier chamber 9. This can be accomplished by providing and using, as necessary, rotary lock valves (such as rotary airlock valves 3), and other ingress/egress control means at inlets/outlets of gasifier chamber 9 and/or the overall gasifier system. However, even when pressure is elevated, proper gasification is facilitated by a starved air environment. Thus, the oxygen content maintained in the gasifier chamber 9 interior should be held ideally at the lowest ratio that will maintain stability of the gasification process, but not more than 50% of the oxygen content necessary for combustion of the contents thereof.

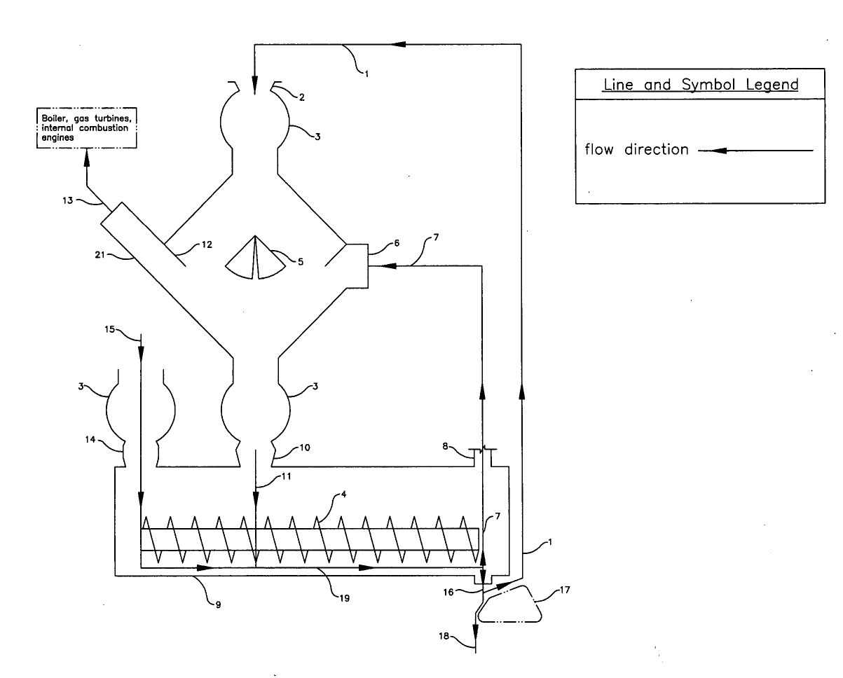

With this in mind, and turning to FIG. 1, it will be seen that a carbonaceous fuel stream 15 is delivered to gasifier chamber 9 by a means such as, but not limited to, a belt, bucket elevator or the like, to an entry valve (airlock valve 3) that allows the entry of the feedstock into the gasifier 9 without the entry of oxygen. Simultaneously, at the introduction of the fuel 15 into the gasifier 9 and at a separate entranceway at air lock valve 3 the correct amount of residue coated metallic particles 11 are deposited into the gasifier 9. The fuel 15 and the metallic particles 11 media will be acted upon by the turbulence created by the rotating auger 4. The difference in the weight of the metallic particle 11 bed material from the fuel 15 will cause the metallic particle 11 bed material to migrate towards the bottom of the auger gasifier 9 and form the primary component of the bed 19 thereof, which is fluidized in accordance with means described in previously cited patents and applications. The physical characters of the metallic particle 11 bed material will create a porous situation that will allow the underfired air to create a fluidized bed 19 environment which is know in the art.

The existing temperature environment of the gasifier chamber 9 will transfer heat to both the fuel 15 and the metallic particles 11 forming bed material 19 simultaneously, while the continued rotation of the auger 4 will propel the fuel 15 from the feed section adjacent fuel stream inlet hopper 14 to the discharge section adjacent ash discharge 16. The diameter of the auger 4 will ensure that it will engage the fuel 15 and a portion of metallic particle 11 bed media. The ash 18 derivative of the fuel 15 with a cleaned portion of metallic particles 1 will exit the gasifier chamber 9 at ash discharge 16. The ash 18 and metallic particles 1 will be separated, advantageously using magnetic means operating on the metallic materials composing metallic particles 1 and/or an appropriately sized grid/grate and/or some other appropriate means with the ash 18 going to a disposal area and the cleaned metallic particles 1 conveyed to the uppermost air lock valve 3 located on the multifunction feeder 21 (or “gas treatment chamber”). The flue gas 7 developed as the product of the gasification process exits the gasifier 9 through a conduit (“flue gas steam discharge 8) and enters the multifunction feeder or gas treatment chamber 21 via flue gas stream entrance 6.

The metallic particles 1 that have been dropped into the multifunction feeder (or gas treatment chamber) 21 are allowed to congregate in sufficient quantity to form a filtration volume and surface. The variable slope controller 5 provided helps to control both the amount of particles 1 entering and the amount of backpressure inside the multifunction feeder 21. The situation now exist whereby the flue gas 7 pressure pushes the flue gas 7 through the predetermined amount of metallic particle 1 retained within the multifunction feeder or gas treatment chamber 21. While the gases 7 pass through, some heat is transferred from the flue gases 7 to the metallic particles 1, and any residue that is entrained within the gas stream 7 will come into contact with, coat the heated metallic particles 1, and adhere to the particles 1. This contact will result in a cleaner flue gas 13 exiting the multifunction feeder or gas treatment chamber 21 than what entered. The now heated and residue coated metallic particles 11 exit the the multifunction feeder or gas treatment chamber 21 and through an airless valve (airlock valve 3) are deposited into the gasifier 9 where the process continues.

Furthermore, the now residue coated metallic particles 11 within the gasifier 9 are heated and become part of the gasification process and this combined with the tumbling action provided by the auger 4 clean the residue off the metallic particles 11, the residue becomes heated and undergoes gasification and is now part of the flue gas 7. This is another positive result produced by the invention as the conversion of residue in this manner eliminates waste and decreases the amount of discharged ash 16.

To reiterate, as raw fuel stream 15 enters the auger gasifier 9 through the fuel stream input hopper 14, the residue coated metallic particles 11 also enter the auger gasifier 9 through the metallic bed particles discharge hopper 10 and are mixed in the auger gasifier 9 with the raw fuel 15 therein. The residue coated metallic particles 11 release the residue thereon after entering the gasifying fuel stream while being conveyed via auger 4 through the auger gasifier 9, thus proportionally reducing the volume of ash 18 discharged. The residue coated metallic particles 11 media forms bed material for the fluidized bed. As the metallic particles 11 are augured through the gasifier 9 the cleaning of said metallic particles 11 is facilitated by the tumbling action generated by the rotation of the auger 4 during the gasification process.

The flue gas stream 7, the product of gasification, is directed by a means of the flue gas stream discharge 8 to the flue gas stream entrance 6 of the multifunction feeder 21, while the mix of ash 19 and cleaned metallic bed particles is discharged via an ash discharge auger 16, passing adjacent to a separator 17 that can advantageously employ magnetic means to magnetically separates the metallic particles 1 from the ash 18. The now cleaned and separated metallic bed particles 1 are recycled into the metallic bed particle inlet hopper 2. Airlock valve 3 meters the correct volume of the metallic particles 1 into the multifunction feeder 20 without allowing the entry of air.

A variable slope controller 5 and a fixed slope controller 12 promote a uniform feed of the metallic bed particle 1 media through the multifunction feeder 20 and reduce a tendency for the creation of stagnant zones within the multifunction feeder 20. Gravity and gas stream pressure direct the metallic bed particle 1 media downward through the multifunction feeder 20. As the cleaned metallic particle 1 bed media stream travels from the metallic bed particle inlet hopper 2 to the metallic bed particle media discharge hopper 10 within the multifunction feeder 20 it encounters and mixes with the hot flue gas stream 7 which engulfs the metallic bed particle 1 media and deposits residue upon the metallic particle 1 bed media, forming residue coated metallic particles 11. This action causes the hot flue gas stream 7 to be filtered and conditioned by the metallic particle 1 bed media. The hot flue gas stream 7 travels through the multifunction feeder 20 and transfers heat to the metallic particle 1 bed media. Conditioned flue gas 7 travels to the flue gas stream exit 13 where through a conduit it will be used in energy devices, such as, but not limited to, boilers, gas turbines or internal combustion engines systems. Continued feeding and operation of the auger gasifier 9 produces the gas to continue the above explained process.

In addition, as may be noted, the metallic particles 1, 11 used in the invention are ideally positioned and suitable for use in catalyzing various chemical reactions. For example, the Fischer-Tropsch process is used to produce a synthetic petroleum substitute from the types of fuels 15 that are anticipated for use with the invention, and is based on the use of metals such as iron, cobalt, nickel and ruthenium as catalysts. In addition to the active metal, the catalysts used for Fischer-Tropsch may also contain a number of promoters, including potassium and copper, as well as high-surface-area binders/supports such as silica, alumina, or zeolites. So, various mixtures and combinations of metallic materials may be used to form particles 1, 11 and other materials beneficial to various catalytic processes may be added thereto or coated thereon. In this as in several other areas of the invention, numerous variations are possible without deviating from and/or exceeding the spirit and scope of the inventive concept. Moreover, many of the above-disclosed and other features and functions, or alternatives thereof, may be desirably combined into various other different systems or applications. Also, numerous presently unforeseen or unanticipated alternatives, modifications, variations or improvements therein may be subsequently made by those skilled in the art which are also intended to be encompassed by the claims that follow.

Finally, the following parts list for the drawing figures may be found to be of assistance in understanding more fully the concepts of my invention:

1) Metallic bed particles

2) Metallic bed particle inlet hopper

3) Airlock valve

4) Auger

5) Variable slope controller

6) Flue gas stream entrance

7) Flue gas stream

8) Flue gas stream discharge

9) Gasifier

10) Metallic bed particle discharge hopper

11) Residue coated metallic particles

12) Fixed slope controller

13) Flue gas stream exit

14) Fuel stream input hopper,

15) Fuel stream

16) Ash discharge

17) Separator

18) Ash

19) Ash and metallic bed particles

20) Multifunction feeder

What is claimed is:

1. A gasifier, comprising:
a gasifier chamber having a fuel inlet for receiving gasifiable materials into its interior;
a fluidized bed including non-gasifiable particles in the interior of said gasifier chamber; and
wherein at least one of
said non-gasifiable particles include metallic particles,
said gasifier further includes a gas treatment chamber receiving gases discharged from said gasifier chamber and said gas treatment chamber contains metallic particles, and
said non-gasifiable particles include metallic particles, said gasifier further includes a gas treatment chamber receiving gases discharged from said gasifier chamber, said gas treatment chamber. contains metallic particles, and said metallic particles are circulated in a closed loop between said gasifier chamber and said gas treatment chamber.

2. The gasifier of claim 1, wherein at least one of
some of said metallic particles serve as a catalyst in the gasification of said gasifiable materials,
some of said metallic particles serve as a catalyst for a Fisher Tropsch chemical process in the gasification of said gasifiable materials,
some of said metallic particles serve to clean gases produced in the gasification of said gasifiable materials,
said metallic particles have at least one of compositions comprised of differing metals, differing sizes, differing volumes, and differing diameters,
said metallic particles have sizes chosen to provide at least one of a selected contact area for gases in the gas treatment chamber, and a selected limit on backpressure for an adequate gas stream flow to gas stream cleaning ratio,
said metallic particles have a heat retention capacity and said heat retention capacity serves to stabilize the operating temperature of the gasifier,
the metallic composition of said metallic particles keeps them from becoming entrained in the gases being discharged from said gasifier chamber,
the metallic composition of said metallic particles allows them to be magnetically separated from ash issuing from said gasifier chamber,
said metallic particles are circulated between said gasifier chamber and said gas treatment chamber, with said metallic particles being cleaned in said gasifier chamber,
said metallic particles are circulated between said gasifier chamber and said gas treatment chamber, with metallic particles in said gas treatment chamber cleaning gases produced in the gasification of said gasifiable materials; and
said metallic particles are circulated between said gasifier chamber and said gas treatment chamber, with at least one of an oxygen deprived environment and an elevated pressure is maintained in said gasifier chamber during the closed loop circulation of metallic particles between the gasifier chamber and the gas treatment chamber.

3. The gasifier of claim 1, wherein said gasifier chamber is an auger gasifier chamber with an auger running therethrough, which auger serves to move at least one of said gasifiable materials and said non-gasifiable materials through said auger gasifier chamber.

4. The gasifier of claim 2, wherein said gasifier chamber is an auger gasifier chamber with an auger running therethrough, which auger serves to move at least one of said gasifiable materials and said non-gasifiable materials through said auger gasifier chamber.

5. The gasifier of claim 4, wherein cleaning of said metallic particles in said gasifier chamber is facilitated by the tumbling of said metallic particles by said auger.

6. The gasifier of claim 1, wherein said gasifier includes a gas treatment chamber receiving gases discharged from said gasifier chamber and said metallic particles are circulated in a closed loop between said gasifier chamber and said gas treatment chamber, and wherein at least one of
the metallic particles in the treatment chamber pass through an airlock valve intermediate the treatment chamber and the gasifier chamber when circulating from the treatment chamber to the gasifier chamber,
the metallic particles in the gasifier chamber pass through an airlock valve intermediate the treatment chamber and the gasifier chamber when circulating from the gasifier chamber to the treatment chamber, and
a variable slope controller is used in said gas treatment chamber to modulate pressure drop within said treatment chamber.

7. The gasifier of claim 2, wherein said gasifier includes a gas treatment chamber receiving gases discharged from said gasifier chamber and said metallic particles are circulated in a closed loop between said gasifier chamber and said gas treatment chamber, and wherein at least one of
the metallic particles in the treatment chamber pass through an airlock valve intermediate the treatment chamber and the gasifier chamber when circulating from the treatment chamber to the gasifier chamber,
the metallic particles in the gasifier chamber pass through an airlock valve intermediate the treatment chamber and the gasifier chamber when circulating from the gasifier chamber to the treatment chamber, and
a variable slope controller is used in said gas treatment chamber to modulate pressure drop within said treatment chamber.

8. A gasifier, comprising:
An auger gasifier chamber having a fuel inlet for receiving gasifiable materials into its interior, which auger gasifier chamber has an auger running therethrough;
a fluidized bed including non-gasifiable metallic particles in the interior of said gasifier chamber such that gasifiable materials and metallic particles can be moved through said auger gasifier chamber via said auger;
a gas treatment chamber receiving a flue gas stream from said gasifier, said gas treatment chamber also containing said metallic particles;
wherein said metallic particles are circulated in a closed loop between said auger gasifier chamber and said gas treatment chamber; and
wherein at least one of an oxygen deprived environment and an elevated pressure is maintained in said auger gasifier chamber during the closed loop circulation of metallic particles between the auger gasifier chamber and the gas treatment chamber.

9. The gasifier of claim 8, wherein at least one of
some of said metallic particles serve as a catalyst in the gasification of said gasifiable materials,
some of said metallic particles serve as a catalyst for a Fisher Tropsch chemical process in the gasification of said gasifiable materials,
some of said metallic particles serve to clean gases produced in the gasification of said gasifiable materials,
said metallic particles have at least one of compositions comprised of differing metals, differing sizes, differing volumes, and differing diameters,
said metallic particles have sizes chosen to provide at least one of a selected contact area for gases in the gas treatment chamber, and a selected limit on backpressure for an adequate gas stream flow to gas stream cleaning ratio,
said metallic particles have a heat retention capacity and said heat retention capacity serves to stabilize the operating temperature of the gasifier,
said metallic particles being circulated between said auger gasifier chamber and said gas treatment chamber are cleaned in said auger gasifier chamber,
the metallic composition of said metallic particles keeps them from becoming entrained in the gases being discharged from said gasifier chamber,
the metallic composition of said metallic particles allows them to be magnetically separated from ash issuing from said gasifier chamber,
said metallic particles being circulated between said auger gasifier chamber and said gas treatment chamber are cleaned in said auger gasifier chamber and cleaning of said metallic particles in said gasifier chamber is facilitated by the tumbling of said metallic particles by said auger, and
said metallic particles in the gas treatment chamber clean the gases produced in the gasification of said gasifiable materials.

10. The gasifier of claim 8, wherein said gasifier includes a gas treatment chamber receiving gases discharged from said gasifier chamber and said metallic particles are circulated in a closed loop between said gasifier chamber and said gas treatment chamber, and wherein at least one of
the metallic particles in the treatment chamber pass through an airlock valve intermediate the treatment chamber and the gasifier chamber when circulating from the treatment chamber to the gasifier chamber,
the metallic particles in the gasifier chamber pass through an airlock valve intermediate the treatment chamber and the gasifier chamber when circulating from the gasifier chamber to the treatment chamber, and
a variable slope controller is used in said gas treatment chamber to modulate pressure drop within said treatment chamber.

11. The gasifier of claim 9, wherein said gasifier includes a gas treatment chamber receiving gases discharged from said gasifier chamber and said metallic particles are circulated in a closed loop between said gasifier chamber and said gas treatment chamber, and wherein at least one of
the metallic particles in the treatment chamber pass through an airlock valve intermediate the treatment chamber and the gasifier chamber when circulating from the treatment chamber to the gasifier chamber,
the metallic particles in the gasifier chamber pass through an airlock valve intermediate the treatment chamber and the gasifier chamber when circulating from the gasifier chamber to the treatment chamber, and
a variable slope controller is used in said gas treatment chamber to modulate pressure drop within said treatment chamber.

12. A gasifier, comprising:
An auger gasifier chamber having a fuel inlet for receiving gasifiable materials into its interior, which auger gasifier chamber has an auger running therethrough;
a fluidized bed including non-gasifiable metallic particles in the interior of said gasifier chamber such that gasifiable materials and metallic particles can be moved through said auger gasifier chamber via said auger;
a gas treatment chamber receiving a flue gas stream from said gasifier, said gas treatment chamber also containing said metallic particles;
wherein said metallic particles are circulated in a closed loop between said auger gasifier chamber and said gas treatment chamber;
wherein at least one of an oxygen deprived environment and an elevated pressure is maintained in said auger gasifier chamber during the closed loop circulation of metallic particles between the auger gasifier chamber and the gas treatment chamber;
wherein the metallic particles in the treatment chamber pass through an airlock valve intermediate the treatment chamber and the gasifier chamber when circulating from the treatment chamber to the gasifier chamber;
wherein the metallic particles in the gasifier chamber pass through an airlock valve intermediate the treatment chamber and the gasifier chamber when circulating from the gasifier chamber to the treatment chamber; and
wherein a variable slope controller is used in said gas treatment chamber to modulate pressure drop within said treatment chamber.

13. The gasifier of claim 12, wherein at least one of
some of said metallic particles serve as a catalyst in the gasification of said gasifiable materials,
some of said metallic particles serve as a catalyst for a Fisher Tropsch chemical process in the gasification of said gasifiable materials,
some of said metallic particles serve to clean gases produced in the gasification of said gasifiable materials,
said metallic particles have at least one of compositions comprised of differing metals, differing sizes, differing volumes, and differing diameters,
said metallic particles have sizes chosen to provide at least one of a selected contact area for gases in the gas treatment chamber, and .a selected limit on backpressure for an adequate gas stream flow to gas stream cleaning ratio,
said metallic particles have a heat retention capacity and said heat retention capacity serves to stabilize the operating temperature of the gasifier,
said metallic particles being circulated between said auger gasifier chamber and said gas treatment chamber are cleaned in said auger gasifier chamber,
the metallic composition of said metallic particles keeps them from becoming entrained in the gases being discharged from said gasifier chamber,
the metallic composition of said metallic particles allows them to be magnetically separated from ash issuing from said gasifier chamber,
said metallic particles being circulated between said auger gasifier chamber and said gas treatment chamber are cleaned in said auger gasifier chamber and cleaning of said metallic particles in said gasifier chamber is facilitated by the tumbling of said metallic particles by said auger, and
said metallic particles in the gas treatment chamber clean the gases produced in the gasification of said gasifiable materials.
